(19) United States
(12) Patent Application Publication
(10) Pub. No.: US 2015/0165348 A1
(43) Pub. Date: Jun. 18, 2015

(54) MANUFACTURING MOLDED PLEATED FILTER CARTRIDGE WITH NO HORIZONTAL EXTENDING LEDGES

(71) Applicant: BHA Altair, LLC, Franklin, TN (US)

(72) Inventor: Alfred Kam Wing Lo, Overland Park, KS (US)

(21) Appl. No.: 14/105,972

(22) Filed: Dec. 13, 2013

(51) Int. Cl. B01D 27/08; B29C 70/68

(52) U.S. Cl. CPC B01D 27/08; B29C 70/68

(57) ABSTRACT

An end cap is molded to a pleated filter. The pleated filter includes an opening in a center thereof. A bottom end of the pleated filter is sealed, and the bottom end is filled with a molding material. The molding material extends into pleats of the pleated filter without extending between the pleats of the pleated filter. The resulting end cap is without horizontal extending ledges.

### BACKGROUND OF THE INVENTION

The invention relates to a pleated filter and, more particularly, to a method of making a pleated filter including a molded end cap that conforms to the pleated shape of the filter media.

Traditional end cap molding forms an end cap 2 with a flat bottom (see FIGS. 1 and 2) that results from the molding material (e.g., urethane resin) moving into the filter element through the center open core as well as into the outside space of the pleats. The traditional filter element is susceptible to dust particle accumulation in both static and pulsed applications on the flat ledge 4 between filter pleats. In certain applications, dust build-up on a pleated filter element is undesirable due to the potential for food/pharmaceutical contamination, or accumulation of combustible dust.

It would be desirable to provide a filter including an end cap without horizontal ledges.

### BRIEF DESCRIPTION OF THE INVENTION

In an exemplary embodiment, a method of molding an end cap to pleated filter includes the steps of (a) filling a mold with a molding material; (b) securing the pleated filter in a sleeve, the sleeve including a central opening aligned with a corresponding opening in the pleated filter; (c) after step (b), pressing the pleated filter and the sleeve into the mold such that the molding material expands through the central opening and the corresponding opening into pleats of the pleated filter; and (d) after step (c), allowing the molding material to cure.

In another exemplary embodiment, a method of molding an end cap to a pleated filter having an opening in a center thereof includes the steps of (a) sealing a bottom end of the pleated filter; and (b) filling the bottom end with a molding material, the molding material extending into pleats of the pleated filter without extending between the pleats of the pleated filter.

In yet another exemplary embodiment, in a method of molding an end cap to pleated filter, a mold is filled with a molding material, and a liner disc is secured to a bottom edge of the pleated filter. The liner disc seals a bottom end of the pleated filter. The pleated filter and the liner disc are secured in a sleeve, which includes a central opening aligned with corresponding openings in the pleated filter and the liner disc. The pleated filter and the sleeve are pressed into the mold such that the molding material expands through the central opening and the corresponding openings into ends of pleats of the pleated filter.

### BRIEF DESCRIPTION OF THE DRAWINGS

FIGS. 1 and 2 show the prior art filter design;

FIG. 3 is a perspective view of the filter according to preferred embodiments;

FIG. 4 is a bottom perspective view of the filter showing the end cap;

FIG. 5 shows a sleeve and liner disc used for manufacturing the molded pleated filter cartridge;

FIG. 6 shows the mold;

FIG. 7 shows the sleeve and filter set in the mold; and

FIG. 8 is a schematic illustration of the manufacturing process.

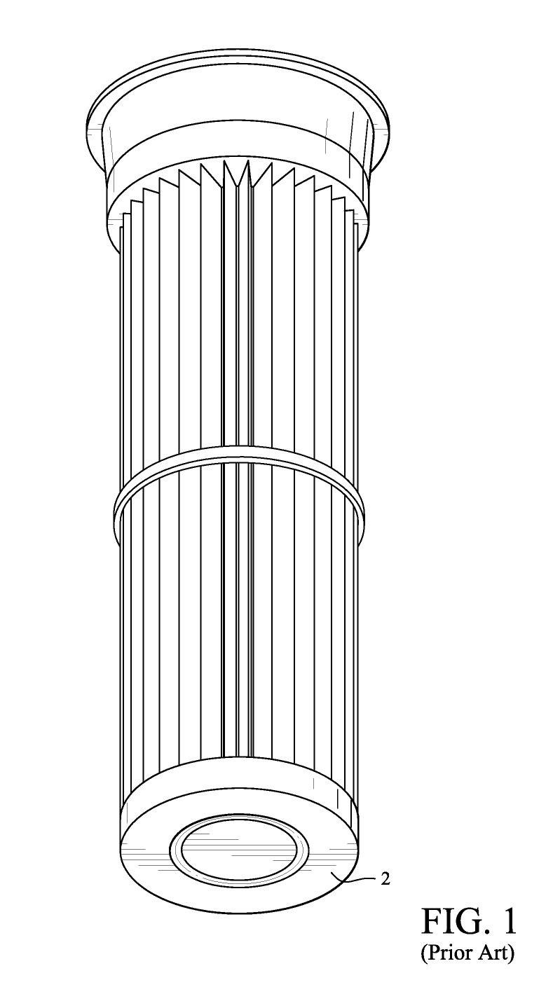

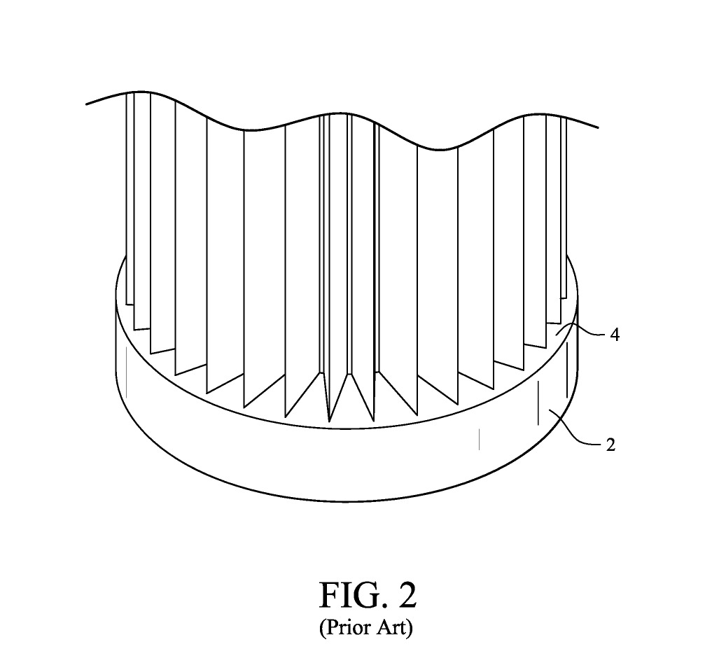

### DETAILED DESCRIPTION OF THE INVENTION

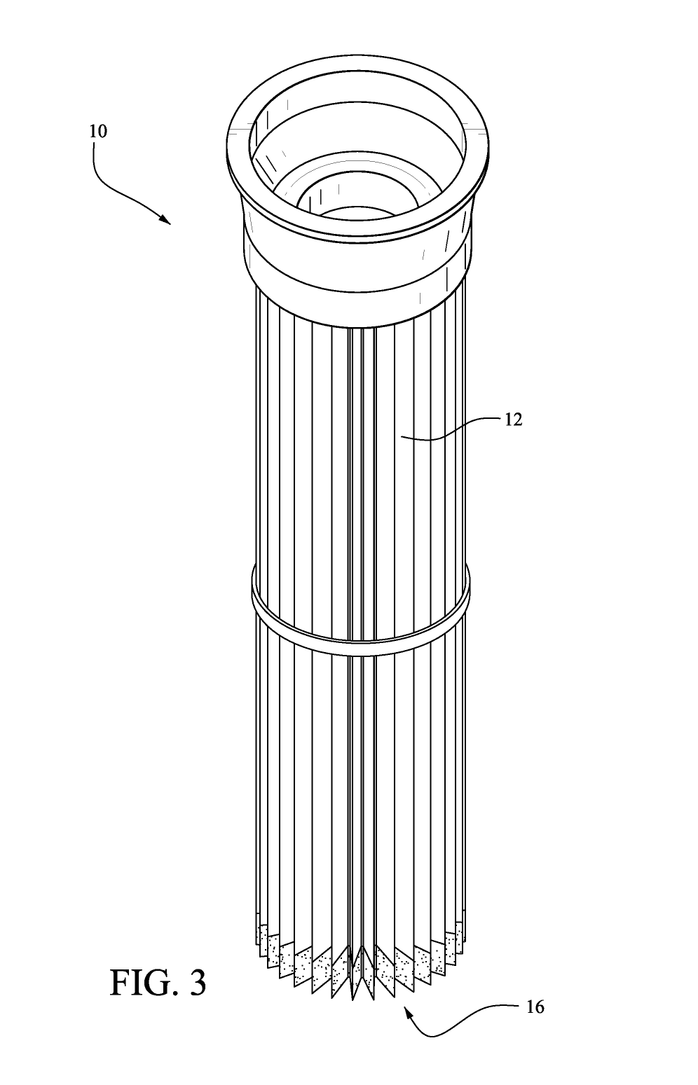

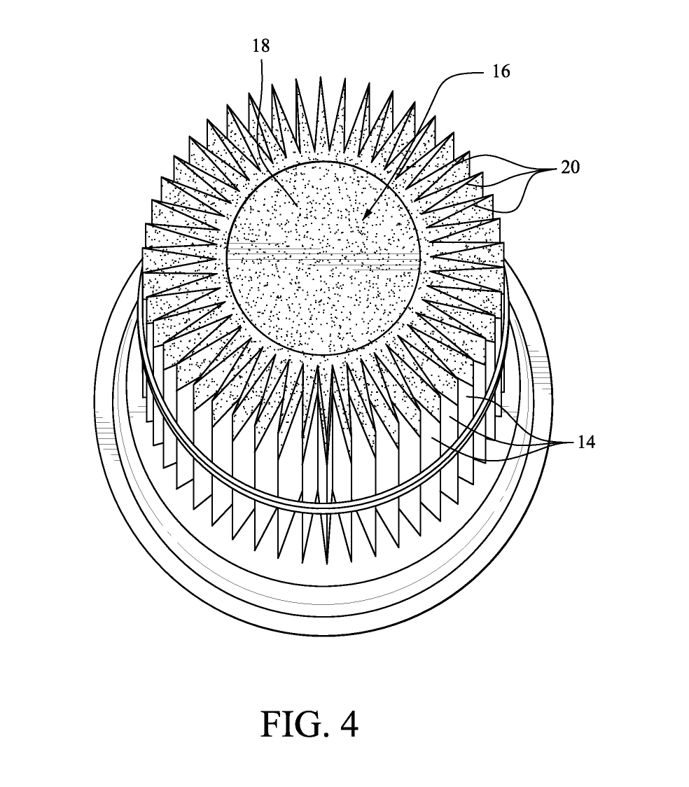

With reference to FIGS. 3 and 4, a filter 10 includes a pleated filter material 12 including a plurality of pleats 14 arranged circumferentially in a star-shaped pattern. An end cap 16 is molded with an axial end of the pleated filter material 12. The end cap 16 includes a central core portion 18 and a plurality of radiant tips 20 extending from the central core portion 18 in a star-shaped pattern corresponding to the star-shaped pattern of the pleated filter material 12.

The circumferentially arranged pleats 14 define an inner diameter and an outer diameter. That is, the outer diameter is defined by the outermost peaks of the circumferentially arranged pleats 14, and the inner diameter is defined by the innermost valleys of the pleats 14. The central core portion 18 of the end cap 16 is disposed within the inner diameter, and the radiant tips 20 extend from the central core portion 18 to the outer diameter. In an exemplary construction, each pleat 14 is defined by a rise from the inner diameter to the outer diameter and a fall from the outer diameter to the inner diameter in a V-shape. As shown in FIG. 4, the radiant tips 20 extend only within the V-shape of the pleats 14.

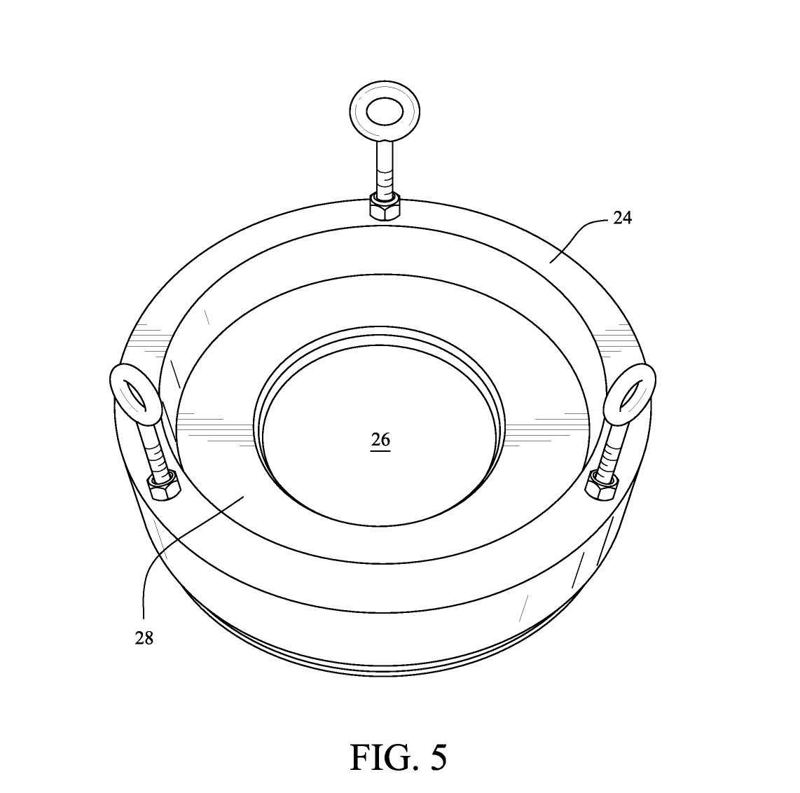

With reference to FIGS. 5-8, the manufacturing process utilizes a mold 22 and a sleeve 24 made of metal or polymer. The sleeve 24 is in the shape of a pan but with a bottom that has a center opening 26 of a size corresponding to the inside diameter or center core opening of the circumferentially arranged pleats 14. An adhesive liner disc 28 may be attached to the bottom edge of the pleated filter material 12 to seal the bottom edge. Although the liner disc 28 is shown in the sleeve 24 in FIG. 5, the liner disc 28 is preferably adhesively secured to the bottom edge of the filter material 12 (although any securing means may be used, including heat, pressure, etc.). Other structure may also be suitable to seal the bottom edge of the filter material 12. The liner disc 28 may be in the form of a ring and applied to the bottom edge of the pleated filter material 12.

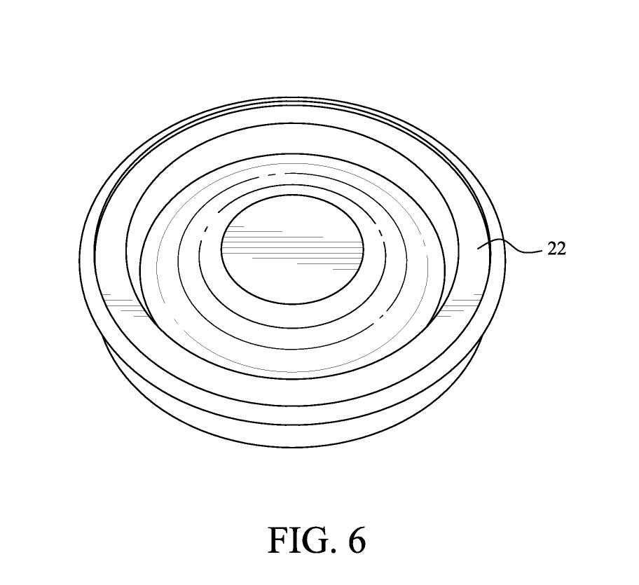

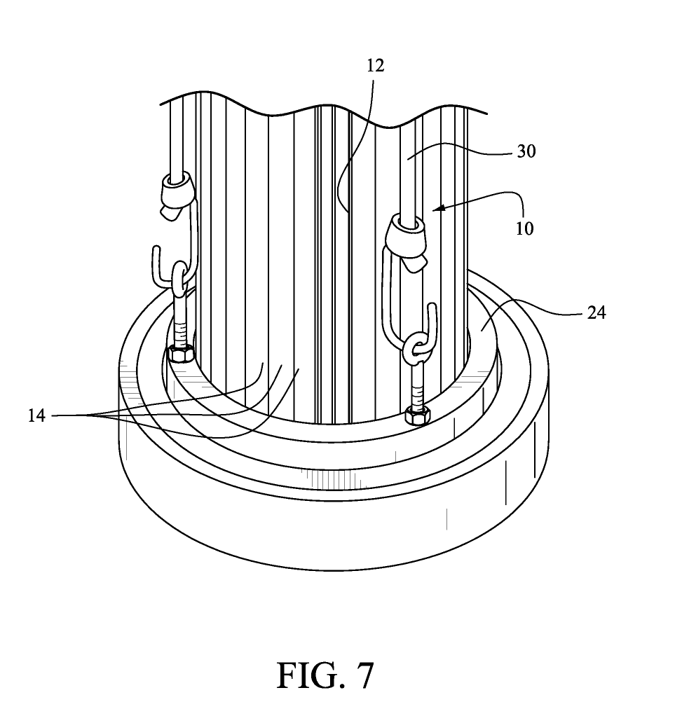

In the manufacturing method, the mold 22 (FIG. 6) is filled with a suitable polymer, such as a polyurethane resin. The filter material 12 is secured in the sleeve 24. In one embodiment, the filter material 12 is urged into engagement with the sleeve by an external force pressing down on the filter material 12. For example, FIG. 7 shows the use of bungee cords secured to the sleeve 24. The top part of the bungee cords 30 may be affixed to a holder or other structure that is supported on top of the filter material 12. As an alternative, a tensioned cable or any similar structure may be used that provides an external force pressing down the filter material 12 onto and into the sleeve 24 so that the filter material 12 and the sleeve 24 become a combined unit when being pressed into the mold 22.

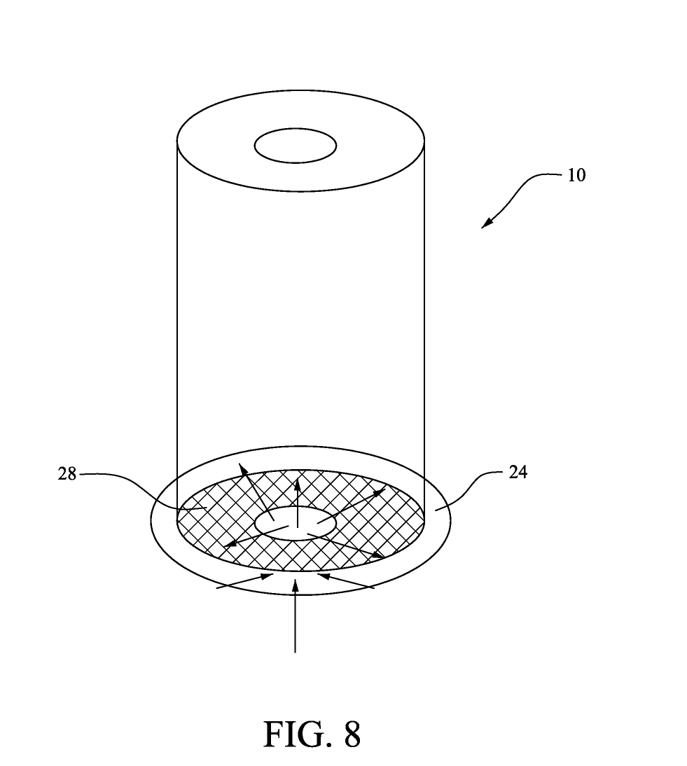

With the filter material 12 secured in the sleeve 24, the filter and sleeve are pressed into the mold 22 such that the molding material expands through the central opening 26 and the corresponding opening in the pleated filter material 12 defined by the inside diameter of the pleats 14 into the pleats 14 of the pleated filter 12 (see FIG. 8). The bottom end of the pleated filter is thus filled from the bottom of the pleated filter.

Traditional molding of the polyurethane resin to form the bottom end cap without the horizontal extending ledges is facilitated by sealing the filter material bottom edge by the resilient surface of the bottom mold and the use of a compression force against the filter pleat material on a top edge or on the top cap. The use of extensive compression force, however, may possibly damage the filter element during manufacturing. On the other hand, insufficient compression will lead to inadequate sealing of the bottom edge of the filter material resulting in leakage. Moreover, the application of the compression force on the filter requires a special tool or weight on the filter in order to facilitate bottom edge sealing. In one embodiment, the polyurethane resin has to be injected into the inside of the filter from the top, thus limiting the length of this type of filter that can be processed. Also, the urethane resin application equipment may require modification in order to dispense the polymer from the top of the filter element down to the bottom edge to form the end cap. In the embodiment with the liner disc 28, the use of an extensive compression force on the filter can be eliminated, and there is no limit on the length of the filter that can be produced as the urethane resin is inserted inside the filter through the bottom center opening.

Because the bottom edge of the filter material is sealed (e.g., by the liner disc 28), the molding material will not flow into the outside space of the pleats 14 to form the horizontal extending ledges. For example, because the bottom end of the filter pleats 14 is sealed by the adhesive liner disc 28, the molding material that flows inside the filter and into the pleats will not move across the bottom edge of the pleats to the outside space of the pleats. Also, as the pleats of the filter material 12 are surrounded by the sleeve 24, the molding material will not be able to move onto the outside space of the pleats from the mold, also preventing the formation of horizontal extending ledges.

After the molding material cures, the pleated filter 12 and sleeve 24 are removed from the mold, and then the pleated filter is removed from the sleeve.

The amount of molding material filled into the mold 22 should be sufficient to fill the pleated filter from the corresponding opening defined by the inside diameter of the pleats 14 to tips of the pleats 14.

The use of the sleeve in the manufacturing methodology serves as a means to separate and to prevent the contact of the molding material with the outside of the pleats thus forming the end cap without horizontal extending ledges at the pleat spacing. The filter element itself acts as the mold to form the star-shaped bottom end cap, and the mold in the process acts as a holding tool of the molding polymer.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method of molding a star-shaped end cap to a pleated filter, the method comprising:
(a) filling a mold with a molding material;
(b) securing the pleated filter in a sleeve, the sleeve including a central opening aligned with a corresponding opening in the pleated filter;
(c) after step (b), pressing the pleated filter and the sleeve into the mold such that the molding material expands through the central opening and the corresponding opening into pleats of the pleated filter; and
(d) after step (c), allowing the molding material to cure.

2. A method according to claim 1, further comprising, after step (d), (e) removing the pleated filter and the sleeve from the mold, and (f) removing the pleated filter from the sleeve.

3. A method according to claim 1, wherein step (b) is practiced by applying a force on the pleated filter toward the sleeve.

4. A method according to claim 3, wherein step (b) is practiced using a bungee cord.

5. A method according to claim 1, further comprising, before step (b), interposing a liner disc between the pleated filter and the sleeve.

6. A method according to claim 5, wherein the interposing step is practiced by securing the liner disc to a bottom edge of the pleated filter.

7. A method according to claim 1, further comprising, before step (b), sealing a bottom end of the pleated filter.

8. A method according to claim 7, wherein the sealing step is practiced by securing a liner disc to a bottom edge of the pleated filter.

9. A method according to claim 1, wherein step (a) is practiced by filling the mold with an amount of the molding material that is sufficient to fill the pleated filter from the corresponding opening to tips of the pleats.

10. A method of molding an end cap to a pleated filter having an opening in a center thereof, the method comprising:
(a) sealing a bottom end of the pleated filter; and
(b) filling the bottom end with a molding material, the molding material extending into pleats of the pleated filter without extending between the pleats of the pleated filter.

11. A method according to claim 10, wherein step (a) is practiced by securing the pleated filter in a sleeve, the sleeve including a central opening aligned with the opening in the pleated filter.

12. A method according to claim 11, wherein step (b) is practiced by expanding the molding material through the central opening of the sleeve and the opening in the pleated filter.

13. A method according to claim 10, wherein step (a) is practiced by securing a liner disc to a bottom edge of the pleated filter.

14. A method according to claim 10, wherein step (b) is practiced by filling the bottom end of the pleated filter from the bottom of the pleated filter.

15. A method of molding an end cap to a pleated filter, the method comprising:
(a) filling a mold with a molding material;
(b) securing a liner disc to a bottom edge of the pleated filter, the liner disc sealing a bottom end of the pleated filter;
(c) securing the pleated filter and the liner disc in a sleeve, the sleeve including a central opening aligned with corresponding openings in the pleated filter and the liner disc; and
(d) after step (c), pressing the pleated filter and the sleeve into the mold such that the molding material expands through the central opening and the corresponding openings into ends of pleats of the pleated filter.

16. A method according to claim 15, further comprising (e) allowing the molding material to cure, (f) removing the pleated filter and the sleeve from the mold, and (g) removing the pleated filter from the sleeve.
